(19) United States
(12) Patent Application Publication
(10) Pub. No.: US 2026/0317144 A1
(43) Pub. Date: Oct. 15, 2026

(54) CAPPING HEAD AND METHOD FOR APPLYING PRE-THREADED CAPS, WITH A VIRTUAL SENSOR FOR THE APPLIED TORQUE

(71) Applicant: AROL S.P.A., Canelli (AT) (IT)

(72) Inventors: Nicola DELL'ISOLA, Canelli (AT) (IT); Fabio PREGNO, Canelli (AT) (IT); Denis RUFFINO, Canelli (AT) (IT); Giuseppe TRIGGIANI, Canelli (AT) (IT)

(21) Appl. No.: 19/481,199

(22) PCT Filed: Apr. 30, 2024
(86) PCT No.: PCT/IB2024/054185

§ 371 Date: Nov. 4, 2025

(30) Foreign Application Priority Data
May 4, 2023 (IT) 102023000008796

(51) Int. Cl. B67B 3/20; B67B 3/26

(52) U.S. Cl. CPC B67B 3/208; B67B 3/261

(57) ABSTRACT

A capping head for applying pre-threaded caps to containers and a system for adjusting closing torque with which a cap is screwed onto a container. The adjusting system is arranged to determine an estimation of closing torque, to compare such estimation with a target value of the same torque and determine an estimation error, and to act onto the motor so as to minimize the estimation error.

### TECHNICAL FIELD

This invention relates to capping plants, and more particularly it concerns a capping head for applying pre-threaded caps (or screw caps, the two terms being used interchangeably here) with a virtual sensor for the applied torque, as well as a capping method using such head.

### BACKGROUND ART

During operations of capping containers, it is usual to monitor the values of certain parameters characterizing the operation. In particular, in the case of capping using screw caps, one of these parameters is the torque applied by the motor, from which the closing torque applied to the cap can be traced back. Such monitoring makes it possible, in particular, to check that a preset limit torque, corresponding to a target closing torque, has been reached and to interrupt the operation in order not to exceed the limit torque.

The most commonly used conventional techniques to control the heads so as not to apply closing torques higher than the target torque are of two distinct types:
1) use of clutches based on different technologies that, when set in motion by an external rotating energy, limit the value of the transmitted torque;
2) use of electronic systems, typically associated with the electric motors that control the movement of the rotating and translating shaft carrying the cap-manipulating members, and capable of controlling the transmitted torque by measuring the current of the motor itself.

JP2005193937A discloses a method and an apparatus for monitoring the capping torque, wherein the cap rotation angle is used to determine the capping quality.

A problem with these known controlling system lies in that, in the case of mechanical systems (case 1), there is no feedback on the applied torque, whereas in the case of electronic systems (case 2), which allow an applied torque value to be traced back in some way by measuring the current supplied by the motor, the measurement is affected by error because the transfer function between the measured current and the assumed applied torque depends on exogenous factors (e.g., temperature or ageing of the magnets). In any case, it is necessary to equip the heads with appropriate external sensors, which is a complex and expensive operation.

In order to solve these problems, the Applicant started from the consideration that a digital model (virtual representation) of a real system has been used in many industrial fields for some time, such digital model providing a snapshot of the state of the system and, thanks to predictive models developed by Artificial Intelligence (AI) algorithms, such as the Kalman filter, allows the future performance of the system to be predicted. In particular, using these techniques, an estimate is made of one or more quantities of interest for an industrial process and the performance of the process is optimized on the basis of this estimate.

In systems in which a motor rotates an operating member, a quantity of interest is often the torque applied to that member. Examples of the use of Kalman filter in such systems are described in JP 2021197752 A, US20200324397 A1 and CN 114310851 A. In particular, JP 2021197752 A and CN 114310851 A use the Kalman filter as a ‘virtual’ sensor for the torque.

The use of the Kalman filter as ‘virtual’ sensor for the torque is also known in the field of bottling (filling, capping, labelling etc. of bottles and the like), in which the invention finds its preferred application. For instance:
WO 2019/137801 A1 discloses a method of detecting inclined screw caps, wherein the Kalman filter is used to obtain reference values with which, during the capping operation, data collected in respect of the actual torque of the electric motor are compared to ascertain whether the cap is applied correctly or is inclined;
US 2021/0087037 A1, on which the preamble of independent claims 1 and 6 are based, discloses a device for closing containers by means of screw caps, wherein a control device dynamically adapts the operation of the motor by using a measured actual value of an operating parameter of the motor (particularly, speed and/or torque), a model of the target closing torque and a model of the actual closing torque. This adaptation is achieved by feeding back the difference between the estimation of the torque and a target torque value.

Now, the Applicant has found that the procedure described in the above document is complicated and performs poorly.

### SUMMARY OF INVENTION

The object of the present invention is to provide an improved capping head and an improved capping method of the aforementioned type that solve the problems of prior art.

To achieve this object, a first aspect of the invention provides a capping head for applying pre-threaded caps to containers, with a system for adjusting the closing torque with which a cap is screwed onto a container, wherein said adjusting system is arranged to determine an estimation of said closing torque, to compare such an estimation with a target value of the same torque and determine an estimation error, and to act onto the motor so as to minimize such an estimation error. The adjusting system comprises:
a unit for estimating the loading torque to which the motor is subjected, which unit recursively carries out said estimation from values of the current applied to the motor and of the rotation speed and the angular position of the rotor of the motor itself;
a unit for estimating the friction torque of the motor and the associated mechanical components, which unit performs said estimation from said values of the current and the rotation speed;
a unit for estimating a torque transmitted to a cap, which unit receives the estimation of the loading torque and the estimation of the friction torque and provides an estimation of the torque transmitted to a cap as the difference between the first and the second received estimations;
a unit for estimating the closing torque, which unit receives the estimation of the torque transmitted to a cap and obtains at each capping cycle the estimation of the closing torque from the values of the estimation of the torque transmitted to a cap relating to the whole cycle.

Preferably, the unit for estimating the loading torque includes a Kalman filter applied to a digital model of the capping head.

According to a feature of the invention, the unit for estimating the friction torque is arranged to determine, at each capping cycle and during a phase in which normally cap screwing does not take place, a friction function linking the friction torque to the speed, and to compute in real time, at each measurement instant during a capping cycle and based on said friction function, the torque corresponding to the rotor speed at said measurement instant.

According to another feature of the invention, the unit for estimating the closing torque is arranged to determine said torque as the maximum value, during a capping cycle, of the estimation of the torque transmitted to a cap.

In a second aspect of the invention, a capping method for applying pre-threaded caps to containers is provided, wherein an adjustment of the closing torque with which the cap is screwed onto a container is performed by means of the following steps: determining an estimation of said closing torque; comparing such an estimation with a target value of the same torque in order to determine an estimation error; and acting onto a motor actuating a capping head in which the method in implemented so as to minimize such an estimation error. Determining the estimation of the closing torque includes the steps of:
getting the values of the current of an electric motor arranged to generate the rotary motion required by the capping and the values of the rotation speed and the angular position of the rotor of the motor itself,
determining an estimation of the loading torque to which the motor is subjected from the values of the current, the rotation speed and the angular position;
determining an estimation of the friction torque of the motor and the associated mechanical components from the values of the current and the rotation speed;
determining an estimation of the torque transmitted to a cap by subtracting, from the estimation of the loading torque, the effects of the friction caused by the motor and the mechanical components, represented by the estimation of the friction torque;
determining, at each capping cycle, the estimation of the closing torque with which a cap is screwed onto a container from the values of the estimation of the torque transmitted to a cap relating to the whole cycle.

Preferably, the estimation of the loading torque is determined by means of a Kalman filter applied to a digital model of the capping head. Among the various estimation devices known to those skilled in art, the Kalman filter has proved to be the most suitable, both concerning the adaptation speed and the performance in terms of noise and accuracy, for use in capping heads, where considerable and very sudden torque changes occur.

According to a feature of the invention, the step of determining the estimation of the friction torque includes the step of:
determining, at each capping cycle and during a phase in which normally cap screwing does not take place, a friction function linking the friction torque to the speed by performing a plurality of rotations at different speeds lying within an interval of interest and in the absence of load; and
determining in real time, at each measurement instant during a capping cycle and based on said friction function, the friction torque corresponding to the rotor speed at said instant.

According to another feature of the invention, the step of determining the estimation of the closing torque includes determining the maximum value, during a capping cycle, of the torque transmitted to a cap.

The invention further relates to a capping machine for applying pre-threaded caps to containers, comprising at least one capping head according to the first aspect of the invention.

### BRIEF DESCRIPTION OF DRAWINGS

These and other features and advantages of the present invention will become evident from the following description of preferred embodiments given by way of non-limiting examples with reference to the annexed drawings, in which:

FIG. 1 is a block diagram of the controlling system of a capping head according to the invention; and

FIG. 2 is a flowchart showing the method according to the invention.

### DESCRIPTION OF EMBODIMENTS

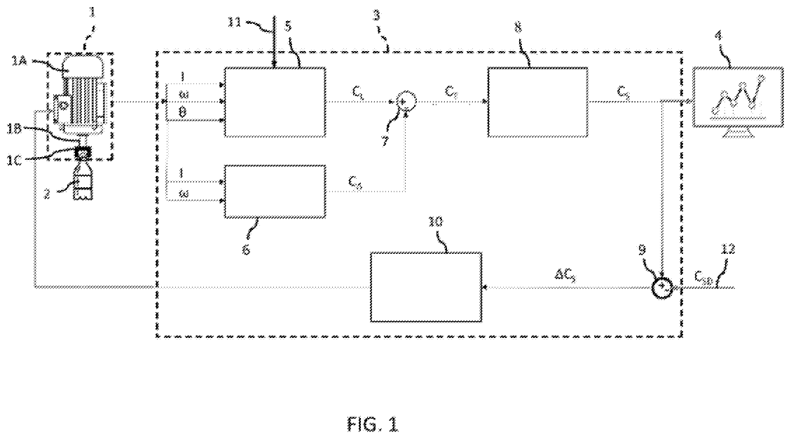

Referring to FIG. 1, reference numeral 1 indicates the capping head according to the invention for applying a screw cap to a container 2, and reference numeral 3 indicates the adjusting system for adjusting the closing torque C_{S} with which the cap is screwed onto the container.

In this figure, the capping head 1 is schematically shown by means of the electric motor 1A, for example, a permanent magnet synchronous motor, which drives into rotation the rotating and translating shaft 1B equipped with cap-manipulating members (the so-called cone-shaped cap chuck) 1C. The motor 1A is associated to means for detecting the applied current I and the rotation speed ω and the angular position θ of the rotor, and thus of the rotating and translating shaft 1B. Such means are well known to the person skilled in the art and are not explicitly represented in the drawings.

The detecting means provide values of current, speed and position to a unit 5 for estimating the loading torque C_{L} to which the motor 1A is subjected during capping. The unit 5 is based on a Kalman filter applied to a digital mode of the capping head 1 and provides an estimation of the loading torque C_{L} by using the relations, well known to the person skilled in the art, which link said torque to current, rotation speed and angular position. In the example considered, in which the motor 1A is a permanent magnet synchronous motor, the unit 5 will therefore apply the electromechanical equation of this type of motor

$$J \frac{d ω}{dt} = {C}_{EM} - B * ω - {C}_{L} \qquad ( 1 )$$

where:
C_{L}, ω and θ have already been defined above;
J is the moment of inertia of the motor;
C_{EM} is the electromagnetic torque, given by the relation

C_{EM}=K_{C}*i_{q} (2)
where i_{q} is the quadrature current of the motor and K_{C} is the so-called torque constant of the motor;
B is the air viscous friction coefficient.

For the practical implementation of the unit 5, it will be necessary to upload into it the parameters of the model (including the values J and B), initialize the state vector and the covariance matrix of the estimation error P and define the covariance matrices Q and R of the processing noise (i.e., the errors in the model) and the measurement error. In particular, the step of defining the matrices constitutes a set-up of the filter. Indeed, these matrices affect, on one part, the speed of estimation of state variables (i.e., speed, position and loading torque) and, on the other part, the attenuation of the noise present in measurements. In the invention, this set-up is effected so as to obtain an adequate estimate of the characteristic dynamics of capping and with a noise level acceptable for the application.

It should be noted that the Kalman filter implementing the unit 5 operates in a standard manner and thus there is no need to give here the equations describing the operation thereof, such equations being well-known to those skilled in the art.

The data to be uploaded for the initial set-up of the unit 5 are provided, for example, by a memory storage device (not shown) external to the system 3, as schematically shown by arrow 11.

The current values I and speed values ω are also fed to a unit 6 for estimating the friction torque C_{A} of the motor and the associated mechanical components. The unit 6 has two tasks. At an initial phase, it has to determine the friction curve linking the friction torque C_{A} to the speed ω. As is known, no function C_{A}=f(ω) with general validity can be provided, because in the capping head 1 there are several mechanical components which generate friction upon rotation (bearings, gaskets, air), and friction further depends, in a way that is difficult to quantify exactly, on several factors such as lubrication, temperature of the lubricants and components and state thereof. However, it is well known that, for some of these components and under certain operating conditions, friction torque is a quadratic function of speed and for others, such as air viscous friction, it is a linear function of speed. Thus, in many cases, an empirical determination is made. In this specific case, tests were carried out in which the capping axis (i.e., the shaft 1b) was rotated at different speeds within the interval of interest and in the absence of load, in a cycle phase in which normally cap screwing does not take place. In this case, the electromagnetic torque delivered by the motor serves to balance the sum of the friction components acting on the shaft. It has been found during these tests that the measured points can be well approximated by a second-degree polynomial curve:

C_{A}=p₁*ω²+p₂*ω+p₃ (3)

Of course, if the application so requires, a polynomial of different degree can be used. The coefficients p₁, p₂, p₃ will continuously be updated based on fresh no-load tests that are carried out periodically. During actual capping, the unit 6 will then provide in real time the torque corresponding to the actual speed. Therefore, the unit will consist of a simple calculation unit applying the relation (3)

The estimation C_{L} of the loading torque and the estimation C_{A} of the friction torque are provided to both inlets of a subtracter 7 which subtracts the second estimation from the first one and outputs an estimation C_{T} of the torque transmitted to the cap net of the friction caused by the motor and the mechanical components. The subtracter 7 implements what has been called “unit for estimating the torque transmitted to a cap” throughout the description and the claims. This estimation C_{T} corresponds approximately to the measurement that would be provided by an ‘actual’ torque sensor hypothetically arranged between the rotating and translating shaft 1B and the cone-shaped cap chuck 1C.

The estimation C_{T} of the torque transmitted to the cap is provided to a unit 8 for estimating the application torque (or cap closing torque) C_{S}, which, at each capping cycle, obtains a unique representative value or estimation of the closing torque C_{S} from the values of estimation C_{T} of the torque transmitted to the cap relating to such cycle. In particular, C_{S} is the maximum value of C_{T} within the cycle, determined after carrying out, if required, some filtering to eliminate any noise. The estimation C_{S} represents the end result of the capping operation and its value must fall within the specification limits provided by the user of the capping head 1 or by the manufacturer of the caps. The estimation C_{S} is provided to a monitoring unit 4 which makes it possible to monitor, from said estimation, the trend of the closing torque C_{S} as capping cycles proceed: this makes it possible to evaluate process performance in real time and without re-opening the caps as required by some prior art solutions. For example, to check the goodness of the estimation, the value provided by a torque meter present on the test bench employed for determining the friction function can be used as a reference.

The estimation C_{S} provided by the unit 8 is also compared with the target value C_{SD} of the closing torque, provided, for example, by a memory storage device (not shown) external to the system 3, as schematically shown by arrow 12, to obtain an estimation error (or difference between target value and estimated value) ΔC_{S}. The comparison is carried out, for example, in a second subtracter 9, which, for example, subtracts the target value C_{SD} from the estimation C_{S}. The estimation error ΔC_{S} is provided to a unit 10 for optimizing those capping parameters that most influence the performance of the process, said optimization unit acting onto the motor 1A so as to vary said parameters and minimize error. The main one of these parameters is the torque value with which the motor is limited in the end phase of capping. Other parameters that can jeopardize the correct performance of the cycle are, for instance:
the reference speed which is imposed at the end phase and on which an ‘overtorque’ imparted to the cap due to dissipation of the accumulated inertia depends; and
the instant at which deceleration from maximum speed to final speed is effected, said deceleration being in turn a function of another parameter called ‘slow torque’.

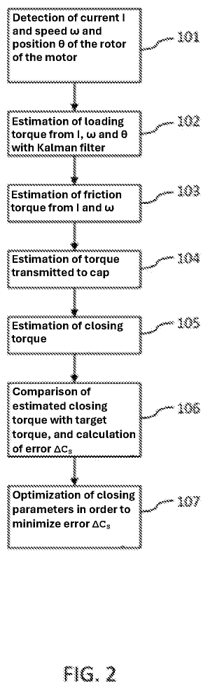

A capping method using the capping head 1 with the adjusting system 3 described above is shown in the flowchart of FIG. 2.

The method provides, at step 101, for detecting the current I applied to the motor 1A and the rotation speed ω and angular position θ of the rotor. The values I, ω and θ are processed in the Kalman filter of the unit 5, which recursively determines the estimation C_{L} of the loading torque (step 102). Simultaneously, the values I and ω are processed in the unit 6 to obtain an estimation C_{A} of the friction torque (step 103). At the subsequent step 104, the estimation C_{T} of the torque transmitted to the cap is determined by subtracting the estimation C_{A} of the friction torque from the estimation C_{L} of the loading torque. At step 105, at each capping cycle, an estimated value C_{S} of the closing torque as the maximum value, during said cycle, of the estimation C_{T} of the torque transmitted to a cap. The estimated value C_{S} is then compared with a target value C_{SD} of the same closing torque (step 106) to obtain an error ΔC_{S} which is provided to the control members of the motor so as to optimize the capping parameters that most influence the progress of the process (i.e., as mentioned above, the torque value with which the motor is limited at the end phase of capping and possibly the reference speed imposed at this end phase and the instant at which deceleration from maximum speed to final speed is effected), and thereby minimize the error itself.

It is apparent that the above description has been given merely by way of example and that numerous variations and modifications are possible without leaving the scope of protection as defined by the appended claims.

1. A capping head (1) for applying pre-threaded caps to containers (2), with a rotating and translating shaft (1B) driven into rotation by an electric motor (1A) and equipped with means (1C) for manipulating the caps, and with a system (3) for adjusting the closing torque with which a cap is screwed onto a container (2), wherein said adjusting system (3) is arranged to determine an estimation (C_{S}) of said closing torque, to compare such an estimation with a target value (C_{SD}) of the same torque and determine an estimation error (ΔC_{S}), and to act onto the motor (1A) so as to minimize such an estimation error (ΔC_{S}), characterized in that for determining the estimation (C_{S}) of the closing torque said adjusting system includes:
a unit (5) for estimating the loading torque (C_{L}) to which the motor (1A) is subjected, which unit recursively carries out said estimation from values of the current (I) applied to the motor (1A) and of the rotation speed (ω) and angular position (θ) of the rotor of the motor itself (1A);
a unit (6) for estimating the friction torque (C_{A}) of the motor (1A) and the associated mechanical components, which unit performs said estimation from said values of the current (I) and the rotation speed (ω);
a unit (7) for estimating a torque (C_{T}) transmitted to a cap, which unit receives the estimation (C_{L}) of the loading torque and the estimation (C_{A}) of the friction torque and provides an estimation (C_{T}) of the torque transmitted to a cap as the difference between the first and the second received estimations; and
a unit (8) for estimating the closing torque, which unit receives the estimation (C_{T}) of the torque transmitted to a cap and obtains at each capping cycle the estimation (C_{S}) of the closing torque from the values of the estimation (C_{T}) of the torque transmitted to a cap relating to the whole cycle.

2. The capping head according to claim 1, wherein the unit (5) for estimating the loading torque includes a Kalman filter applied to a digital model of said capping head (1).

3. The capping head according to claim 2, wherein the unit (6) for estimating the friction torque (C_{A}) is arranged to determine, at each cycle and during a phase in which normally cap screwing does not take place, a friction function linking the friction torque (C_{A}) to the speed (ω), and to compute in real time, at each measurement instant during a capping cycle and based on said friction function, the torque corresponding to the rotor speed at said measurement instant.

4. The capping head according to claim 3, wherein the unit (8) for estimating the closing torque (C_{S}) is arranged to determine said torque as the maximum value, during a capping cycle, of the estimation (C_{T}) of the torque transmitted to a cap.

5. A capping machine comprising at least one capping head (1) according to claim 4.

6. A capping method for applying pre-threaded caps to containers (2), wherein an adjustment of the closing torque with which a cap is screwed onto a container (2) is performed by determining an estimation (C_{S}) of said closing torque, comparing such an estimation (C_{S}) with a target value (C_{SD}) of the same torque in order to determine an estimation error (ΔC_{S}) and acting onto an electric motor (1A) actuating a capping head (1) so as to minimize such an estimation error (ΔC_{S}), characterized in that the determination of the estimation (C_{S}) of the closing torque includes the steps of:
getting (101) the values of the current (I) of an electric motor (1A) arranged to generate the rotary motion required by the capping and the values of the rotation speed (ω) and the angular position (θ) of the rotor of the electric motor itself (1A),
determining (102) an estimation (C_{L}) of the loading torque to which the electric motor (1A) is subjected from the values of the current (I), the rotation speed (ω) and the angular position (θ);
determining (103) an estimation (C_{A}) of the friction torque of the electric motor (1A) and the associated mechanical components from the values of the current (I) and the rotation speed (ω);
determining (104) an estimation (C_{T}) of the torque transmitted to a cap by subtracting (104) the estimation (C_{A}) of the friction torque from the estimation (C_{L}) of the loading torque; and
determining (105), at each capping cycle, the estimation (C_{S}) of the closing torque with which a cap is screwed onto a container (2) from the values of the estimation (C_{T}) of the torque transmitted to a cap relating to the whole cycle.

7. The method according to claim 6, wherein the step (102) of determining an estimation (C_{L}) of the loading torque is performed by means of a Kalman filter applied to a digital model of said capping head (1).

8. The method according to claim 7, wherein the step (103) of determining the estimation (C_{A}) of the friction torque includes the steps of:
determining, at each cycle and during a phase in which normally cap screwing does not take place, a friction function linking the friction torque (C_{A}) to the speed (ω) by performing a plurality of rotations at different speeds lying within an interval of interest and in the absence of load; and
determining in real time, at each measurement instant during a capping cycle and based on said friction function, the friction torque (C_{A}) corresponding to the rotor speed at said instant.

9. The method according to claim 8, wherein the step (105) of determining the estimation (C_{S}) of the closing torque includes, at each cycle, determining the maximum value, during such a cycle, of the torque (C_{T}) transmitted to a cap.

10. The method according to claim 6, wherein the step (103) of determining the estimation (C_{A}) of the friction torque includes the steps of:
determining, at each cycle and during a phase in which normally cap screwing does not take place, a friction function linking the friction torque (C_{A}) to the speed (ω) by performing a plurality of rotations at different speeds lying within an interval of interest and in the absence of load; and
determining in real time, at each measurement instant during a capping cycle and based on said friction function, the friction torque (C_{A}) corresponding to the rotor speed at said instant.

11. The method according to claim 8, wherein the step (105) of determining the estimation (C_{S}) of the closing torque includes, at each cycle, determining the maximum value, during such a cycle, of the torque (C_{T}) transmitted to a cap.

12. The capping head according to claim 1, wherein the unit (6) for estimating the friction torque (C_{A}) is arranged to determine, at each cycle and during a phase in which normally cap screwing does not take place, a friction function linking the friction torque (C_{A}) to the speed (ω), and to compute in real time, at each measurement instant during a capping cycle and based on said friction function, the torque corresponding to the rotor speed at said measurement instant.

13. The capping head according to claim 1, wherein the unit (8) for estimating the closing torque (C_{S}) is arranged to determine said torque as the maximum value, during a capping cycle, of the estimation (C_{T}) of the torque transmitted to a cap.

14. A capping machine comprising at least one capping head (1) according to claim 1.
